(19) United States
(12) Patent Application Publication
(10) Pub. No.: US 2010/0305874 A1
(43) Pub. Date: Dec. 2, 2010

(54) ELECTRONIC WEAR STATE DETERMINATION IN A VALVE ARRANGEMENT

(75) Inventors: Urs E. MEIER, Wuerenlingen (CH); Detlef Pape, Nussbaumen (CH)

Correspondence Address: BUCHANAN, INGERSOLL & ROONEY PC, POST OFFICE BOX 1404, ALEXANDRIA, VA, 22313-1404, US

(73) Assignee: ABB Technology AG, Zurich (CH)

(21) Appl. No.: 12/786,926

(22) Filed: May 25, 2010

(30) Foreign Application Priority Data
May 27, 2009 (DE) 10 2009 022 891.8

(51) Int. Cl. G06F 19/00

(52) U.S. Cl. 702/34

(57) ABSTRACT

A method is provided for determining the electronic wear state of a valve arrangement for controlling a process medium flow. A valve element is arranged to move axially within a valve housing, is reset by a spring, and is moved by application of control pressure via an I/P converter. The I/P converter ensures a constant opening cross section at least over a portion of the switching stroke, in the case of which the time at which various positions of the valve element along the ventilating and/or venting distance are reached is determined by means of a position sensor system, and this time is used to mathematically derive the speeds of the valve element prevailing at these positions by means of an evaluation unit. The change profile of the speeds represents a measure of the wear state of the valve mechanism.

### RELATED APPLICATIONS

This application claims priority under 35 U.S.C. §119 to German Patent Application No. 10 2009 022 891.8 filed in Germany on May 27, 2009, the entire content of which is hereby incorporated by reference in its entirety.

### FIELD

The present disclosure relates to a method for the determination of an electronic wear state of a valve arrangement, such as a pneumatic actuating drive, the valve element of said actuating drive, which valve element is arranged such that it can move axially within a valve housing and is reset by a spring, being moved by application of control pressure via an I/P converter. Furthermore, the disclosure also comprises a valve arrangement which has means for implementing a method of this kind.

### BACKGROUND INFORMATION

The term “position regulator,” used in the present disclosure, represents a mechatronic system which controls the auxiliary energy of a pneumatic actuating drive on the basis of one or more input signals, in order to move a valve element of the pneumatic actuating drive to a specific position. In order to operate, the position regulator requires pressurized gas(e.g., compressed air) as auxiliary energy, and electrical energy as well.

A pneumatic position regulator which is known for operating a process valve has the following core components. With a pneumatic system, the drive chambers of a single-acting or double-acting pneumatic valve are ventilated or vented deliberately as a function of one or more input signals. The pneumatic system can also include an auxiliary energy supply line, one or more pilot valve arrangements, and control pressure supply lines to the drive chambers in order to control the ventilation and/or venting of the drive chambers. The movement and positions of the valve element are represented as one or more signals with the aid of a position sensor as a position feedback sensor. Furthermore, a control electronics system is provided which has a microcontroller and receives one or more input signals. The firmware in the control electronics processes the input signals and the signals from the position sensor system to form output signals which are used as input signals for the pneumatic actuating drive.

Such pneumatic actuating drives can be subdivided into pivoting drives and linear-movement drives. In a linear-movement drive, the linear movement of the output drive of the actuating drive is transmitted directly to a linearly operating actuating member. In contrast, in pivoting drives, the linear movement of the output drive of the actuating drive is converted into a rotary movement by suitable means.

The pneumatic actuating drive and the position regulator are linked by means of an adapter kit. The adapter kit includes components which transmit the movement and position of the actuating drive with respect to the position feedback sensor system to the positioning regulator.

One disadvantage with the use of a pneumatic valve as a constituent part of an installation, for example of an automation installation, is that the entire installation or vehicle can fail in the event of an unpredicted failure of the valve, and this can lead to downtimes in production. Multiway valves are particularly susceptible to failure in pneumatic valves since they are subject to particularly severe mechanical alternating loading during operation.

In order to cope with these disadvantageous issues, it has been normal practice until now to either replace a defective constituent part of the valve mechanism only after it becomes defective, or, on the other hand, to provide a replacement, by way of precaution, after the estimated service life of the valve has elapsed. However, in the last-mentioned method, replacement was frequently carried out well before the actual wear limit, since there are large deviations between the estimated service life and the actual service life on account of the variation range.

In addition to the undersirable failure of pneumatic valves, it is also possible for progressive wear in an installation to result in the switching of the valve taking place continuously more slowly, which can result in disadvantageous overlapping phenomena, which can in turn lead to impermissible system states in the installation.

DE 102 22 890 A1 discloses a technical solution which addresses the problem described above and proposes specific electronic monitoring means for wear state monitoring of the switching mechanism of a pneumatic valve. An electronics unit is provided which, on the input side, receives the electrical drive signal for the pneumatic valve and an electrical reaction signal which follows a drive pulse, and the electronics unit determines the switching delay as a measure of the wear state of the switching mechanism from the signals by comparing the time interval between the drive signal and the reaction signal. The reaction signal is determined by means of a pressure sensor which is integrated on the operating line side in the valve housing. This solution is based on the knowledge that lengthening of the switching time of a valve is directly related to the wear state over its entire operating time. This known solution therefore makes use of timely identification of undesirably long switching times to allow deliberate replacement of valves or parts of said valves that are subject to wear and which would fail in the foreseeable future. This ensures preventative maintenance of pneumatic installations.

However, this technical solution appears to have the disadvantage of the pressure sensor system which is required for this purpose in order to determine the reaction signal to an electrical drive pulse. This is because correct operation of a pressure sensor cannot be ensured in all circumstances over the entire life of the valve. Furthermore, pressure sensors result in consumption of additional electrical energy, and are not required during normal operation of the valve.

There are known solutions which manage without an additional pressure sensor for wear state determination of the valve mechanism; however these solutions are designed for bistable valves without resetting springs and are therefore not suitable for transfer to monostable valves since the position-dependent spring force can have an influence on the measurement. Furthermore, with this solution, it is difficult to assess whether measurement differences are caused by negligible changes in the pneumatic system or by changes in position of the switching element.

### SUMMARY

An exemplary embodiment provides a method for determining the electronic wear state of a valve mechanism of a valve arrangement. The valve mechanism is configured to move axially within a valve housing, be reset by a spring, and be moved by application of control pressure via an I/P converter. The exemplary method includes: ensuring, by the I/P converter, a constant opening cross section at least over a portion of a switching stroke of the valve mechanism; determining, by a position sensor system, at the constant opening cross section, a time at which various positions of the valve mechanism along at least one of a ventilating and venting distance are reached; mathematically deriving, by an evaluation unit, speeds of the valve mechanism prevailing at the various positions; and determining, by the evaluation unit, a change profile of the derived speeds, wherein the change profile of the derived speeds represents a measure of the wear state of the valve element.

An exemplary embodiment provides a valve arrangement. The exemplary valve arrangement includes a valve housing, and an I/P converter configured to apply a control pressure. The exemplary valve arrangement also includes a valve mechanism configured to move axially within the valve housing, and to be moved by way of an end-face control piston by application of the control pressure from the I/P converter. In addition, the exemplary valve arrangement includes electronic means for determining a wear state of the valve mechanism. According to an exemplary embodiment, the electronic means includes a position sensor system configured to, when the I/P converter maintains a constant opening cross section at least over a portion of a switching stroke of the valve mechanism, determine a time at which various positions of the valve mechanism along at least one of a ventilating and venting distance are reached. In addition, the electronic means includes an evaluation unit configured to mathematically derive speeds of the valve element prevailing at the various positions, and to generate a change profile of the derived speeds, wherein the derived speeds represent a measure of the wear state of the valve mechanism.

An exemplary embodiment provides a valve arrangement. The exemplary valve arrangement includes a valve housing, and an I/P converter configured to apply a control pressure. The exemplary valve arrangement also includes a valve mechanism configured to move axially within the valve housing, and to be moved by way of an end-face control piston by application of the control pressure from the I/P converter. In addition, the exemplary valve arrangement includes a position sensor system configured to, when the I/P converter maintains a constant opening cross section at least over a portion of a switching stroke of the valve mechanism, determine a time at which various positions of the valve mechanism along at least one of a ventilating and venting distance are reached. Furthermore, the exemplary valve arrangement includes an evaluation unit configured to mathematically derive speeds of the valve element prevailing at the various positions, and to generate a change profile of the derived speeds, to determine a wear state of the valve mechanism based on the derived speeds.

### BRIEF DESCRIPTION OF THE DRAWINGS

Additional refinements, advantages and features of the present disclosure are described in more detail below with reference to exemplary embodiments illustrated in the drawings, in which:

FIG. 1 shows a schematic illustration of an exemplary valve arrangement having electronic means for determination of a pressure-sensor operating state;

FIG. 2 shows a graph for illustrating the speed of an upward movement of the valve element for various levels of friction with a fixed air inlet opening according to an exemplary embodiment of the present disclosure;

FIG. 3 shows a graph for illustrating the speed of a downward movement of the valve element for various levels of friction with a fixed air inlet opening according to an exemplary embodiment of the present disclosure;

FIG. 4 shows a graph for illustrating the speed of an upward movement with a fixed level of friction and different air inlet openings according to an exemplary embodiment of the present disclosure; and

FIG. 5 shows a graph for illustrating the speed of a downward movement of the valve element with a fixed level of friction and with different air inlet openings according to an exemplary embodiment of the present disclosure.

### DETAILED DESCRIPTION

Exemplary embodiments of the present disclosure provide a method for determining the electronic wear state of the valve mechanism of a pneumatic actuating drive. The exemplary method provides reliable forecast results for future wear limits or instances of failure with the aid of simple electronic components.

According to an exemplary embodiment of the present disclosure, an I/P converter of the pneumatic actuating drive ensures a constant opening cross section at least over a portion of the switching stroke. At the constant opening cross section, a position sensor system determines time(s) at which various positions of the valve element are reached along the ventilating and/or venting distance, and this time is used to mathematically derive the speeds of the valve element prevailing at these positions by means of an evaluation unit. The change profile of the derived speeds represents a measure of the wear state.

An advantage of the solution according to exemplary embodiments of the present disclosure is, for example, that the use of a pressure sensor within the valve can be entirely dispensed with for the purpose of determining the wear state. The exemplary method according to the present disclosure also provides the preconditions for, in addition to changes in the friction values in the valve mechanism, changes in respect of the spring constant and the parameters of the I/P converter to be determined separately and to be supplied to a diagnosis system. Furthermore, the solution according to the exemplary method of the present disclosure is suitable, for example, for monostable valves in which the valve element is operated from one side by pilot control, whereas the starting position is assumed by a resetting spring. In contrast, for bistable valves with pilot control at both sides, it is more difficult to draw conclusions about the wear state by means of the creation of change profiles of the speed of the switching element since ventilation and venting of the two control chambers which are situated opposite the switching element takes place at the same time.

Often, only the pressure in one of the control chambers changes as function of the I/P converter and the other control chamber remains at a constant pressure. However, if the behavior of the I/P converter is known, the solution according to the disclosure can by all means be used for bistable valves.

An exemplary and advantageous measure of the present disclosure provides that a plurality of positions, both along the ventilation distance and along the venting distance, are included in the evaluation in order to determine the speeds prevailing there. Based on the different pressure situations at the I/P converter, the behavior of the compressed air flow to and from actuators connected to the valve, and therefore the movement speed of the valve element, is different during the ventilating and venting stroke. When a monostable valve is vented, a relationship is produced between the venting flow rate and the reduced force of the resetting spring such that the speed depends solely on the actual opening of the UP converter, and therefore the speed is constant. During ventilating, however, the flow rate is constant and the speed of the switching element reduces as the switching stroke rises. The exact link between the reduction in speed and the position is determined by the relationship between the spring force of the resetting spring and the friction. By a plurality of speed determination operations of the switching element during the ventilating stroke and subsequent determination of the change profile, a change in the spring force and other parameters of the pneumatic system can be determined. If, in addition, the speed of the switching element is determined during the venting stroke, a more exact analysis values for the pneumatic system can be obtained.

A further exemplary and advantageous measure of the present disclosure proposes storing the change profile of the speed profile over the switching stroke, together with the date of the measurement, in a memory element. Corresponding data records form a database which the evaluation unit can in turn access in order to create a wear state forecast from the history of stored change profiles by comparison. In the simplest case, this can be done by extrapolation. If a first determination of the change profile is created and stored when the valve is activated, a change in the friction behavior can already be identified with an actual change profile which is determined at a different time from this for the purpose of wear state identification.

A reduction in the speed values in the change profile indicates a wear-related increase in friction in the valve mechanism. However, it is also possible for the speed values in the change profile to increase in comparison to a prior measurement, this indicating a reduction in the friction in the valve mechanism. In this case, there may be a leak in the seal, this assisting the linear movement during ventilation of the valve element. It is also feasible within the scope of the disclosure to carry out an evaluation in respect of such a leak in the seal.

An exemplary method according to the present disclosure for determining the wear state of the valve mechanism of a monostable pneumatic valve, which can be switched by means of an UP converter, can be implemented by the integration of a position sensor system for determining the time at which various positions of the switching element along the ventilating or venting distance are reached. A downstream evaluation unit evaluates the measured switching times measured as a result by mathematically calculating the speed of the valve element prevailing at the various positions from said switching times. A stored data record including the respective value pair positions with the associated speed, which data record represents the speed profile of the valve mechanism, is created from this. The comparison of two speed profiles, which have been created at different times from one another after many valve switching cycles, can be used to determine a change profile by calculating the difference, where the change profile is used as a measure of the wear state of the valve mechanism. If the change profile shows a significant reduction in the speeds at a plurality of positions of the switching stroke, this indicates, for example, progressive wear of the valve mechanism. It goes without saying that the other parameters which influence the measurement have to be constant.

The position sensor system which is provided for the purpose of determining the switching points can be formed from a plurality of integrated binary proximity switches which are spaced apart from one another in the valve housing. If an inductive measurement principle is used for this purpose, each of the proximity switches interacts with a permanent magnet which is integrated in the valve element, and the proximity switch, which is inductive in this respect, outputs a binary signal when the maximum value of the voltage which is induced by the movement of the valve element is reached. As an alternative to this, it is also feasible to form the position sensor system as an analog travel measurement sensor which is integrated in the valve housing along the switching distance. A travel measurement sensor of this kind can, for example, be in the form a kind of slide resistor with which any desired position of the valve element along the switching distance can be established. However, a travel measurement sensor which operates in a contact-free manner should preferably be used in order to prevent friction-related wear on the sensor.

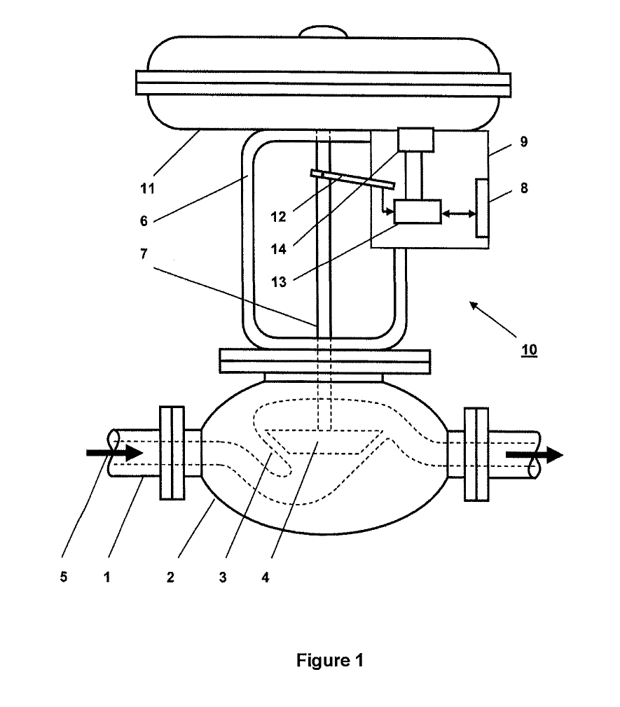

FIG. 1 shows a schematic illustration of an exemplary valve arrangement having electronic means for the determination of a pressure-sensor operating state. As shown in FIG. 1, a valve housing 2 of a process valve is installed in a pipeline 1 of a process installation. In an interior region of the valve housing 2, the valve housing 2 has a valve element 4, which interacts with a valve seat 3, for controlling the amount of a process medium 5 passing through the pipeline 1. The valve element 4 is operated linearly by a pneumatic actuating drive 10 via a pushrod 7. The pneumatic actuating drive 10 is connected via a yoke 6 to the valve housing 2 of the process valve. A digital position regulator with a positioning regulator 13 is fitted to the yoke 6. The travel of the pushrod 7 into the region of the position regulator 13 is signaled via a position sensor 12. The detected travel is compared with a predefined setpoint value within the positioning regulator 13, and the pneumatic actuating drive 10 is operated as a function of the determined regulation discrepancy. The pneumatic actuating drive 10 comprises an I/P converter 14 in the region of the positioning regulator 13, in order to convert the electrical regulation signal of the determined regulation discrepancy into an adequate control pressure. The control pressure is passed via a pressure medium supply to a drive chamber 11 of the pneumatic actuating drive 10. A membrane-like control piston is integrated within the drive chamber 11 and operates the pushrod 7.

The pressure within the drive chamber 11 can be measured by means of a pressure sensor 9 which is likewise associated with the pneumatic actuating drive 10. The pressure sensor 9 signals the actually applied pressure to an evaluation unit 8. While the I/P converter 14 ensures a constant opening cross section over a portion of the switching stroke of the valve element 4, in the case of which the position sensor system 12 determines the time at which various positions of the valve element 4 along the ventilating or venting distance are reached, and the evaluation unit 6 mathematically derives the speeds of the valve element 4 prevailing at these positions. The change profile of the derived speeds represents a measure of the wear state of the valve mechanism. The evaluation unit 8 creates a wear state forecast from a history of stored speed profiles by comparison.

The evaluation unit 8 determines the speed profile of the valve element 4 over the switching stroke on the basis of the following mathematical relationships:

the speed x′ of a valve, to which a control pressure is applied only in one direction and which is monostable in this respect, can be approximately described, during movement with a constant cross section of the I/P converter 14 which generates the control pressure, as follows:

$$\dot{x} = \frac{\dot{m} R T}{k ( x + {x}_{0} ) + f ( \dot{x} ) + {p}_{0} A} \qquad ( 1 )$$

where \dot{x} represents the position of the valve slide, \dot{m} represents the flow rate to or from the actuator, k represents the spring constant, kx₀ represents the initial spring tension, f represents the friction force, R represents the specific gas constant, T represents the temperature, and P₀A represents the influence of the ambient pressure on the second side of the valve element.

This equation can vary on account of the gas expansion of the compressed air actually produced, but the basic behavior can be described in this way. The flow rate to and from the actuator is determined by the opening cross section of the I/P converter 14 and the pressure conditions upstream and downstream of the I/P converter 14. In order to ventilate the actuator, a high pressure difference normally prevails across the I/P converter 14 based on the high pressure on the feed pressure supply side which can be approximately 5 barᵣₑₗ, for example, and the pressure loss on the actuator side of less than 1.4 barᵣₑₗ, for example. This produces a supercritical flow rate in the I/P converter 14 which produces a constant flow rate that is only dependent on the opening cross section A_{d} of the I/P converter 14 and the feed pressure which is normally constant. Furthermore, the following equation is produced on the basis of the preceding equation (1):

$$\dot{x} ∼ \frac{{A}_{d}}{k x + f ( \dot{x} ) + C} \qquad ( 2 )$$

If the friction is low, the spring force will dominate the movement of the valve element 4 and the speed of the valve element 4 will greatly reduce as the gradient increases. If the friction is increased, the influence of the spring force will reduce as the valve element 4 moves and the position depends on the speed. The speed of the movement of the valve element 4 is then more linear or constant over the switching stroke. The speed profile can be determined, and the friction can therefore be measured, by determining the speed at various position points in accordance with exemplary embodiments of the present disclosure.

During the resetting movement of the valve element 4, the pressure difference across the I/P converter 14 is lower, such as 1 barᵣₑₗ, for example. The flow rate through the I/P converter 14 is therefore supercritical and, in a first approximation, is proportional to the pressure difference across the I/P converter 14. This pressure is again proportional to the actual spring force, and therefore to the position and to the friction, for the return movement, as expressed by the following approximate equation:

\dot{m}˜A_{d}(p_{act.}−p_{env.})˜A_{d}kx+f(\dot{x}) (3)

If this relationship is used in equation (1), it is shown, by canceling out, that the movement speed is determined mainly by the opening cross section of the I/P converter 14. Therefore, a constant speed is set by means of the position which, independently of the spring force or the friction, is only dependent on the opening cross section of the I/P converter 14. Therefore, during the backward movement, the state of the pneumatic assembly can be checked to determine, for example, whether the opening is blocked by dirt or the like, or whether there is a change in the ratio between the effective opening of the I/P converter 14 and the signal for the I/P converter 14.

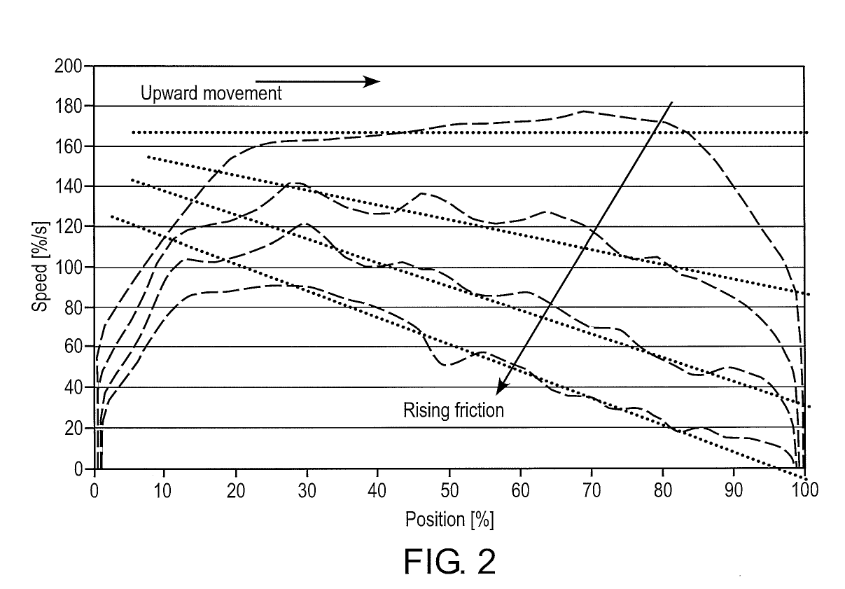

According to FIG. 2, which illustrates an upward movement of the valve element at different levels of friction, if the movement starts with a 0% opening travel at a speed of 0%/s, the valve element 4 first initially accelerates until the speed at which further or other forces determine the movement are reached. This acceleration phase is not of interest for the solution according to exemplary embodiments of the present disclosure and is not considered any further. The region which seems to be significant begins only after this acceleration phase is complete at approximately 10 to 20%.

If the friction in the system is very low, the acceleration theoretically has to continue until the forces produced by the high speed limit the acceleration. However, in this case, this process is already limited by the pneumatic system, and for limiting the acceleration, higher speeds and the compressed air for filling the drive chamber also have to be adjusted correspondingly quickly. However, since the supplied air is limited by the pressure in the supply line and the air inlet opening, the speed of the actuating drive 10 is determined here by the amount of adjusted air and not by the friction forces and other forces in the mechanical system. However, the supplied compressed air is constant, as described above, and therefore an approximately constant speed also results. This can be seen from the uppermost curve in the graph. If the friction now rises, the friction forces and therefore the forces in the mechanical system also increase. If the friction reaches a specific variable, these forces, at the speed which could be previously reached in the friction-free state, would be greater than the forces generated by the application of pressure to the piston, and the speed therefore falls. This creates a force equilibrium and the movement of the system is now predominantly determined by the mechanical forces. Equation (1) described above holds true.

Since the mechanical forces are made up of both the friction and the force of the spring, the speed decreases as the position of the valve element 4 increases, as is also illustrated in the graph of FIG. 2. The greater the friction, the greater the fall in speed. This means that conclusions can be drawn about the friction from the profile of the speed curve which falls in this way. The speed decreases as the friction increases; the gradient of the fall in speed increases as the friction increases. In a first assumption, it could be assumed that it was already possible to determine the friction from the absolute value of the speed, for example by comparison with a value from an aged pneumatic actuating drive. However, since these curves are also influenced by the amount of supplied compressed air, via the pressure inlet opening which can likewise be varied, this is not directly possible in this way. The following graphs therefore serve to show the difference between these two effects.

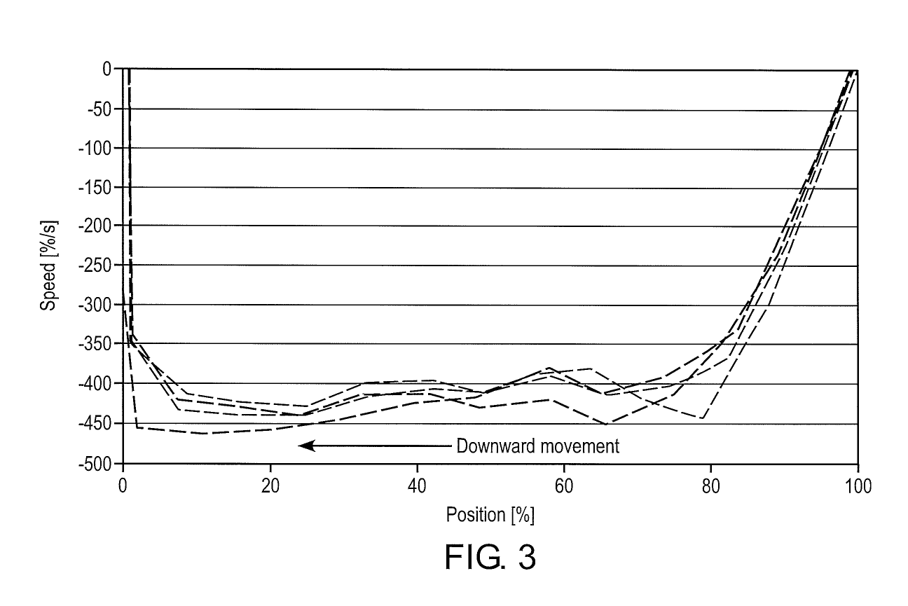

In the graph according to FIG. 3, which shows the behavior as the valve element moves downward, the falling force of the spring as the position falls and the reduction in the air flowing out are compensated for by the low pressure in the drive chamber 11. As a result, a constant speed is likewise produced, this speed being independent of the friction however.

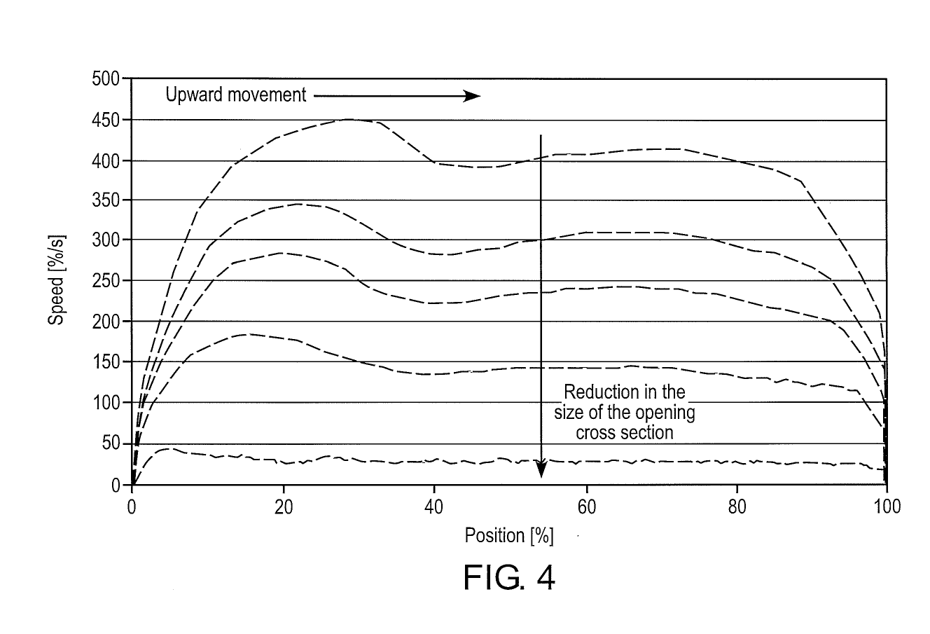

FIG. 4 illustrates the upward movement of the valve element with different cross-sectional openings since another air supply can also influence the speed. A change in the air supply leads to a different speed of the valve element 4; however, this effect is independent of the position of the valve element and an approximately constant speed is produced, in each case at a different level depending on the opening cross section.

Therefore, conclusions cannot be drawn about the effect of friction from the absolute value of the speeds. If, however, the gradient of the speed profile is taken into consideration, this provides an indication of the friction. Therefore, if both the absolute value and the gradient are compared with the starting values for an unaged valve mechanism, it is thus possible to draw conclusions about the two fault variables: changes in the pneumatic system due to different opening cross section and friction. Therefore, both variables can be determined from this diagnosis. However, it is also possible to simply take into consideration only the gradient, in order to determine the friction from this.

Furthermore, this could be extended by the form of the fall in speed being examined further. Since the term f(dx) can contain different terms for the different forms of friction, the exact form of the speed profile can be determined by the dominant type of friction and behave differently for different types of friction. Therefore, conclusions can be drawn about the type of friction from the profile of the fall in speed.

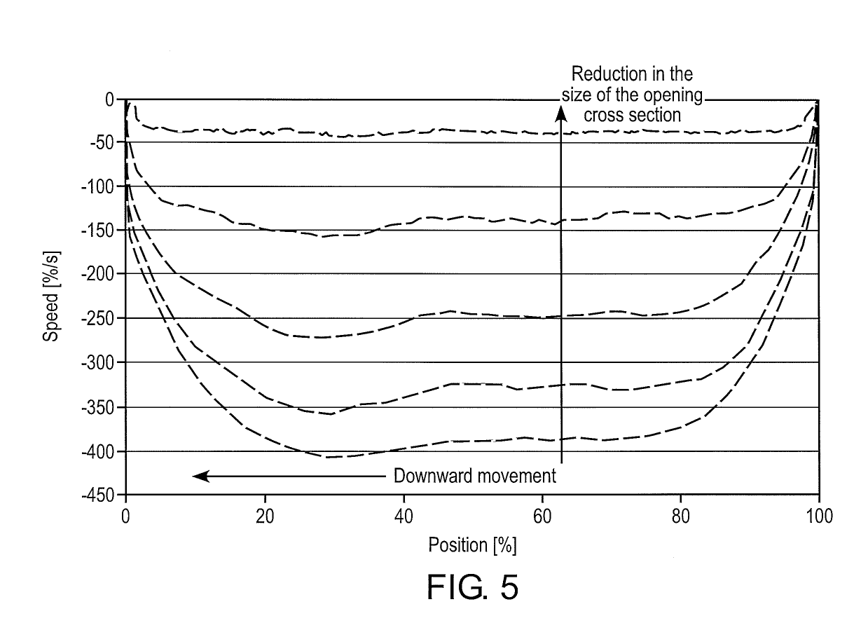

The graph according to FIG. 5 illustrates a downward movement of the valve element with different cross section openings. It is similar to FIG. 3, but the speed varies on account of the different cross section openings.

The evaluation unit 8, pressure sensor 9, position sensor 12, position regulator 13 and I/P converter 14 were each described above with reference to the respective functions they perform according to an exemplary embodiment. It is to be understood that one or more these elements can be implemented in a hardware configuration. For example, the respective components can comprise a computer processor configured to execute computer-readable instructions (e.g., computer-readable software), a non-volatile computer-readable recording medium, such as a memory element (e.g., ROM, flash memory, optical memory, etc.) configured to store such computer-readable instructions, and a volatile computer-readable recording medium (e.g., RAM) configured to be utilized by the computer processor as working memory while executing the computer-readable instructions. The evaluation unit 8, pressure sensor 9, position sensor 12, position regulator 13 and I/P converter 14 may also be configured to sense, generate and/or operate in accordance with analog signals, digital signals and/or a combination of digital and analog signals to carry out their intended functions.

The present disclosure is not restricted to the above-described exemplary embodiments. Instead, modifications to the exemplary embodiments are feasible, and these modifications are covered by the scope of protection of the following claims. Therefore, the present disclosure is, in particular, not restricted to pneumatic actuating drives. Similarly, the exemplary solutions described above can also be applied to other seat valves or slide valves in which the speed profile of the closure body which operates the valve seat can be monitored during the switching stroke.

It will be appreciated by those skilled in the art that the present invention can be embodied in other specific forms without departing from the spirit or essential characteristics thereof. The presently disclosed embodiments are therefore considered in all respects to be illustrative and not restricted. The scope of the invention is indicated by the appended claims rather than the foregoing description and all changes that come within the meaning and range and equivalence thereof are intended to be embraced therein.

### LIST OF REFERENCE SYMBOLS

1 Pipeline
2 Valve housing
3 Valve seat
4 Valve element
5 Process medium
6 Yoke
7 Pushrod
8 Evaluation unit
9 Pressure sensor
10 Pneumatic actuating drive
11 Drive chamber
12 Position sensor
13 Positioning regulator
14 I/P converter

What is claimed is:

1. A method for determining the electronic wear state of a valve mechanism of a valve arrangement, the valve mechanism being configured to move axially within a valve housing and be reset by a spring, and being moved by application of control pressure via an I/P converter, the method comprising:
ensuring, by the I/P converter, a constant opening cross section at least over a portion of a switching stroke of the valve mechanism;
determining, by a position sensor system, at the constant opening cross section, a time at which various positions of the valve mechanism along at least one of a ventilating and venting distance are reached;
mathematically deriving, by an evaluation unit, speeds of the valve mechanism prevailing at the various positions; and
determining, by the evaluation unit, a change profile of the derived speeds, wherein the change profile of the derived speeds represents a measure of the wear state of the valve element.

2. The method as claimed in claim 1, comprising:
evaluating a plurality of positions along at least one of the ventilation and the venting distance to determine the respective speed prevailing at each of the plurality of positions.

3. The method as claimed in claim 1, comprising:
storing the speed profile over the switching stroke, together with a date of the measurement, in a memory element of the evaluation unit.

4. The method as claimed in claim 3, wherein the evaluation unit creates a wear state forecast from the history of stored speed profiles by comparison.

5. The method as claimed in claim 1, comprising:
deriving the speed of the valve during the switching stroke with the I/P converter constantly open on the basis of the following equation:
$$\dot{x} ∼ \frac{{A}_{d}}{k x + f ( \dot{x} ) + C} .$$

6. The method as claimed in claim 1, comprising:
evaluating an increase in the speed values in the speed profile as a result of reducing the friction of the valve element as a leak in a seal of the actuating drive.

7. A valve arrangement comprising:
a valve housing;
an I/P converter configured to apply a control pressure;
a valve mechanism configured to move axially within the valve housing, to be moved by way of an end-face control piston by application of the control pressure from the I/P converter; and
electronic means for determining a wear state of the valve mechanism, the electronic means comprising:
a position sensor system configured to, when the I/P converter maintains a constant opening cross section at least over a portion of a switching stroke of the valve mechanism, determine a time at which various positions of the valve mechanism along at least one of a ventilating and venting distance are reached; and
an evaluation unit configured to mathematically derive speeds of the valve element prevailing at the various positions, and to generate a change profile of the derived speeds, wherein the derived speeds represent a measure of the wear state of the valve mechanism.

8. The valve arrangement as claimed in claim 7, wherein the position sensor comprises a binary proximity switch.

9. The valve arrangement as claimed in claim 7, wherein the position sensor comprises an analog travel measurement sensor which is integrated in the valve housing along the switching distance.

10. The valve arrangement as claimed in claim 7, wherein the valve element comprises a valve tappet,
wherein one side of the valve tappet is configured to have a control pressure applied thereto via the I/P converter, and is the valve tappet is configured to be reset by a spring.

11. The method as claimed in claim 1, wherein the valve arrangement is a pneumatic actuating drive, and the valve mechanism is a valve element of the pneumatic actuating drive.

12. The valve arrangement as claimed in claim 7, wherein the valve arrangement is a pneumatic actuating drive, and the valve mechanism is a valve element of the pneumatic actuating drive.

13. A valve arrangement comprising:
a valve housing;
an I/P converter configured to apply a control pressure;
a valve mechanism configured to move axially within the valve housing, to be moved by way of an end-face control piston by application of the control pressure from the I/P converter;
a position sensor system configured to, when the I/P converter maintains a constant opening cross section at least over a portion of a switching stroke of the valve mechanism, determine a time at which various positions of the valve mechanism along at least one of a ventilating and venting distance are reached; and
an evaluation unit configured to mathematically derive speeds of the valve element prevailing at the various positions, and to generate a change profile of the derived speeds, to determine a wear state of the valve mechanism based on the derived speeds.

14. The valve arrangement as claimed in claim 13, wherein the position sensor comprises a binary proximity switch.

15. The valve arrangement as claimed in claim 13, wherein the position sensor comprises an analog travel measurement sensor which is integrated in the valve housing along the switching distance.

16. The valve arrangement as claimed in claim 13, wherein the valve element is comparises a valve tappet,
wherein one side of the valve tappet is configured to have a control pressure applied thereto via the UP converter, and is the valve tappet is configured to be reset by a spring.

17. The valve arrangement as claimed in claim 13, wherein the valve arrangement is a pneumatic actuating drive, and the valve mechanism is a valve element of the pneumatic actuating drive.
